(19) United States
(12) Patent Application Publication
(10) Pub. No.: US 2007/0023534 A1
(43) Pub. Date: Feb. 1, 2007

(54) Water-source heat pump control system and method

(76) Inventor: Mingsheng Liu, Omaha, NE (US)

Correspondence Address: MICHAEL BEST & FRIEDRICH, LLP, 100 E WISCONSIN AVENUE, MILWAUKEE, WI, 53202, US

(21) Appl. No.: 11/491,768

(22) Filed: Jul. 24, 2006

Related U.S. Application Data
(60) Provisional application No. 60/701,597, filed on Jul. 22, 2005.

(51) Int. Cl. G05D 23/12; F25D 17/00

(52) U.S. Cl. 236/1 C; 62/179; 62/180

(57) ABSTRACT

A method and system of controlling a water heat pump system. The water heat pump system includes a fan, a water pump, and a boiler. The method includes determining a system time characteristic, determining a heat rejection rate based on the system time characteristic, and determining a loop flow rate based on the heat rejection rate. The method also includes sensing a loop flow rate of the water heat pump system, comparing the sensed loop flow rate with the determined loop flow rate, and modulating a speed of the water pump based on the comparing.

### RELATED APPLICATION

This application claims priority to U.S. Provisional Patent Application Ser. No. 60/701,597, filed on Jul. 22, 2005, the entire contents of which are incorporated herein by reference.

### FIELD

Embodiments of the invention relate generally to control systems and methods, and particularly to systems and methods to improve efficiency of heat pump systems.

### BACKGROUND

Various types of facilities, such as buildings, industrial production facilities, medical buildings, manufacturing assemblies, and laboratories, often use heat pump systems to condition various spaces of the facilities. Such heat pump systems can generally provide both heating and cooling using heat pumps tied to one or more water sources.

The effectiveness of water-source heat pump systems often depends on system processes that add heat to, or reject heat from, spaces to be heated or cooled. Such systems may use heat pumps to control a loop water temperature between 55° F. and 90° F. In some cases, such systems use a cooling tower to remove heat if the loop water temperature exceeds 90° F., and a boiler to add heat if the temperature falls below 55° F.

The loop water temperature can fluctuate significantly due to loads present in a facility. If a heat loss (e.g., through ventilation) exceeds those loads, a significant energy surge occurs as additional pumps and/or a boiler are activated to replenish heat. Low compressor efficiency and high pump power consumption can result, particularly if inefficient heat pumps are present in a water-source heat pump system.

### SUMMARY

In one embodiment, the invention provides a method of controlling a water heat pump system. The water heat pump system includes a fan, a water pump, and a boiler. The method includes determining a system time characteristic, determining a heat rejection rate based on the system time characteristic, and determining a loop flow rate based on the heat rejection rate. The method also includes sensing a loop flow rate of the water heat pump system, comparing the sensed loop flow rate with the determined loop flow rate, and modulating a speed of the water pump based on the comparing.

In another embodiment, the invention provides a controller for controlling a water heat pump system. The heat pump system includes a variable speed cooling tower fan, a water pump, a boiler operable to supply water at a plurality of temperatures, and a sensing device operable to sense a loop flow rate of the water heat pump system. The controller includes a timing module, a heat rejection module, a loop flow module, a comparator, and a modulator. The timing module determines a system time characteristic. The heat rejection module determines a heat rejection rate based on the system time characteristic. The loop flow module determines a loop flow rate based on the heat rejection rate. The comparator compares the sensed loop flow rate with the determined loop flow rate. The modulator modulates a speed of the water pump based on the comparing by the comparator.

Embodiments of the invention can optimize a loop pump temperature and water flow rate to ensure optimal heat pump efficiency and minimal pump energy consumption. Some embodiments herein can reduce loop pump power by about 50 percent and compressor power by about 30 percent.

Other aspects of the invention will become apparent by consideration of the detailed description and accompanying drawings.

### BRIEF DESCRIPTION OF THE DRAWINGS

FIG. 1 is a schematic diagram of a water-source heat pump system according to an embodiment of the invention.

FIG. 2 is a block diagram of a controller according to an embodiment of the invention.

FIG. 3 is a flow chart illustrating exemplary processes carried out in the controller of FIG. 2.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As should also be apparent to one of ordinary skill in the art, the systems shown in the figures are models of what actual systems might be like. Many of the modules and logical structures described are capable of being implemented in software executed by a microprocessor or a similar device or of being implemented in hardware using a variety of components including, for example, application specific integrated circuits (“ASICs”). Terms like “controller” may include or refer to both hardware and/or software. Furthermore, throughout the specification capitalized terms are used. Such terms are used to conform to common practices and to help correlate the description with the coding examples, equations, and/or drawings. However, no specific meaning is implied or should be inferred simply due to the use of capitalization. Thus, the claims should not be limited to the specific examples or terminology or to any specific hardware or software implementation or combination of software or hardware.

Embodiments of the invention provide control systems and methods that can be retrofitted in existing water-source heat pump systems, or can be incorporated in new systems.

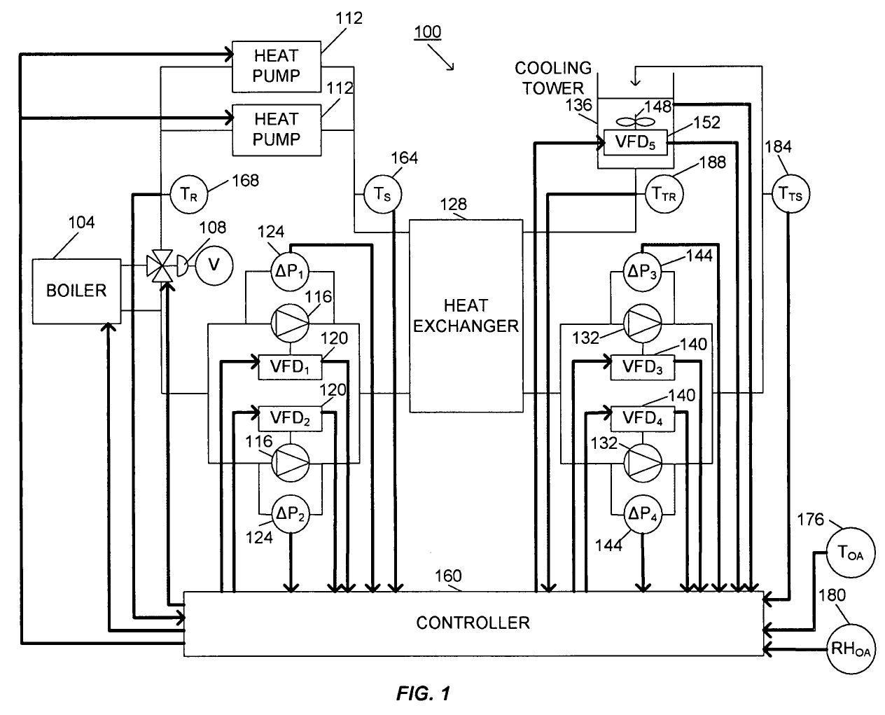

FIG. 1 shows a water-source heat pump system 100 that includes a boiler 104 coupled to a valve 108 that limits an amount of return water from a plurality of heat pumps 112. The boiler 104 heats water collected by the heat pumps 112 and supplies the heated water downstream in the system 100. Although the embodiment shown in FIG. 1 includes only two heat pumps 112, the system 100 can include more or fewer heat pumps. The system 100 also includes a plurality of loop pumps 116 coupled to a plurality of respective variable frequency drives (“VFDs”) 120 to drive the loop pumps 116. Across each of the loop pumps 116 is a pressure differential sensor or a pump head 124 that measures a pressure differential between an input and an output of the loop pump 116. In other embodiments, the system 100 includes more or fewer loop pumps 116, VFDs 120, and loop pump heads 124.

The system 100 includes a heat exchanger 128 to collect water from the boiler 104 and the loop pumps 116. A plurality of tower pumps 132 located downstream from the heat exchanger 128 pump the water from the heat exchanger 128 to a cooling tower 136 located further downstream and typically on a rooftop. Like the loop pumps 116, a plurality of VFDs 140 control the respective tower pumps 132, and a plurality of pump heads 144 measure a plurality of pressure differentials across the respective tower pumps 132. In other embodiments, the system 100 includes more or fewer tower pumps 132, VFDs 140, and tower pump heads 144.

The cooling tower 136 receives water from the tower pumps 132, and cools the water with a fan 148 coupled to another VFD 152 that controls a speed of the fan 148. The heat exchanger 128 collects the water from the cooling tower 136, and supplies the water back to the heat pumps 112, thus completing a water flow path.

The system 100 also includes a controller 160 to collect and process information. In the embodiment shown, the system 100 includes a loop supply water temperature sensor 164 that senses temperature of the water being supplied to the heat pumps 112. A loop return water temperature sensor 168 measures temperature of the water being collected from the heat pumps 112. The controller 160 also receives signals from an outside air temperature sensor 176 and an outside air relative humidity sensor 180 configured to measure the temperature and the relative humidity of the outside air, respectively. The controller 160 also receives signals from a tower supply water temperature sensor 184 that measures the temperature of the water being supplied to the cooling tower 136. Similarly, the controller 160 receives signals from a tower return water temperature sensor 188 that measures the temperature of the water being returned to the heat exchanger 128 from the cooling tower 136.

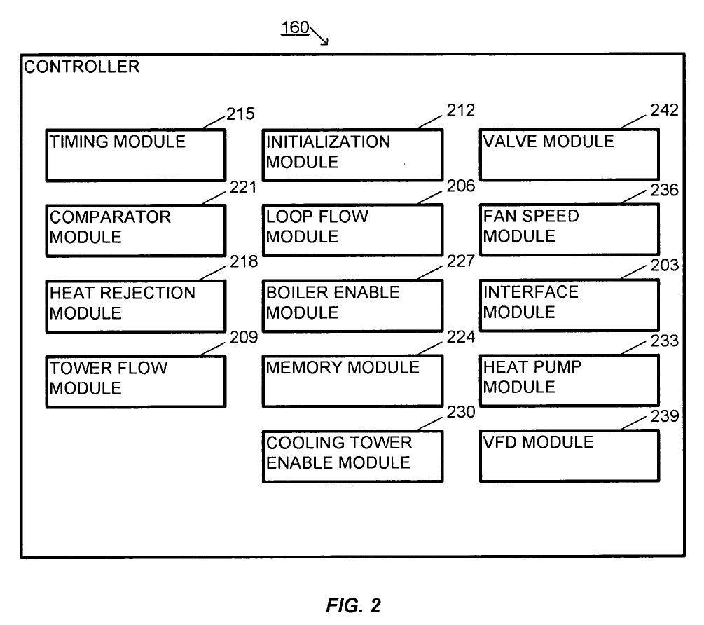

FIG. 2 shows a block diagram of the controller 160 of FIG. 1. The controller 160 includes an interface module 203 that is configured to receive a plurality of air-related conditions and system operating conditions from sensors of the system 100 of FIG. 1, such as the outside air temperature sensor 176, the relative humidity sensor 180, the loop pump head sensors 124, and the tower pump head sensors 144. Based on one or more of the sensed conditions, a loop flow module 206 determines a flow rate of the water at the loop pumps 116; a tower flow module 209 determines a flow rate of the water at the tower pumps 132; and an initialization module 212 initializes operating parameters, as described in greater detail below.

The controller 160 also includes a timing module 215 to determine a time characteristic of the system 100, and a heat rejection module 218 to determine a heat rejection rate based on the time characteristic. A comparator module 221 receives and compares inputs. For example, the comparator module 221 compares a loop pump flow rate with a loop pump set point that can be retrieved from a memory module 224. Similarly, the comparator module 221 compares a tower pump flow rate with a tower pump set point. Additionally, the comparator module 221 compares sensed temperatures with a temperature set point retrieved from the memory module 224. The comparator module 221 also compares a heat rejection rate with a plurality of heat rejection rate set points.

The controller 160 enables the boiler 104 and the cooling tower 136 of FIG. 1 via a boiler enable module 227 and a cooling tower enable module 230, respectively. A heat pump module 233 activates or enables the heat pumps 112. A fan speed module 236 adjusts a speed of the fan 148, while a VFD module 239 sends a plurality of control signals to control a plurality of VFDs 120 and 140. The controller 160 also includes a valve module 242 to control the valve 108.

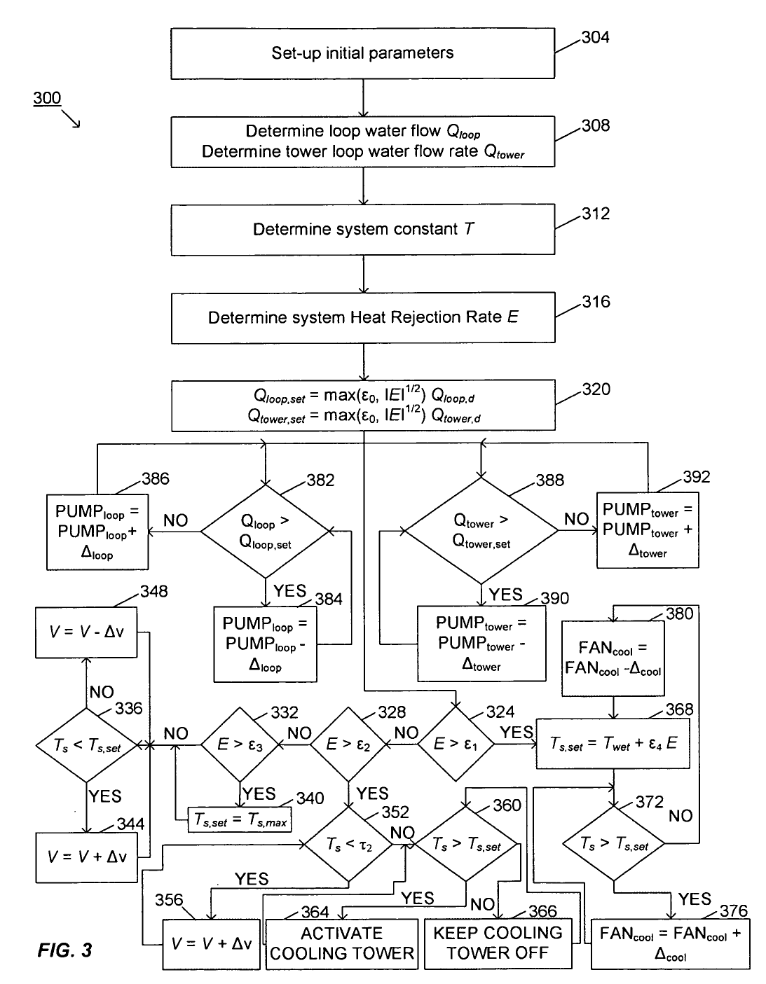

FIG. 3 is a flow chart illustrating a water-source heat pump control process 300 carried out by the controller 200 of FIG. 2. At block 304, the process 300 initializes system operating conditions, such as a loop pump speed (“N”) measured in revolutions-per-minute (“RPM”), a design loop pump speed (“N_{d}”) measured in RPM, and a time characteristic of the system 100 of FIG. 1. The system operating conditions can be determined, for example, by using sensed parameters directly, performing one or more computations using sensed parameters, etc.

At block 308, the process 300 determines a loop flow rate (“Q”) of the loop pumps 116 of FIG. 1 as follows. A specific equation for determining the water flow rate is used depending on a type of pump curve associated with the loop pumps 116. Pumps typically can be characterized by a pump curve, which may be steep or flat. Pumps with a steep pump curve include pumps whose differential pressure or pump head increases as a result of decreasing water flow rates (“Q”) at the same pump speed (“N”). Pumps with a flat pump curve include pumps whose differential pressure or pump head remains generally constant when the pump flow rate (“Q”) changes. For such pumps, the pump power varies significantly when the pump flow rate changes at the same pump speed.

For example, the process 300 can use EQN. (1) to determine the flow rate (“Q”) of the loop pumps and the tower pumps, which is measured in gallons-per-minute (“GPM”), for pumps with a steep pump curve. EQN. (1) is based on a measured pump head (“H”), and a ratio (“ω”) between the pump speed (“N”) that is measured in revolutions-per-minute (“RPM”) and a design pump speed (“N_{d}”) that is also measured in RPM. In some embodiments, the design pump speed is about 1,450 RPM.

$$Q = ( \frac{- {a}_{1} - \sqrt{{a}_{1}^{2} - 4 {a}_{2} ( {a}_{0} - \frac{H}{{ω}^{2}} )}}{2 {a}_{2}} ) ω \qquad ( 1 )$$

In EQN. (1), a₀, a₁, and a₂ are pump curve coefficients obtained from the pump curve, typically provided by manufacturers of the pumps 116, 132.

Further, the process 300 can use EQN. (2) to determine the pump airflow rate (“Q”) for pumps with a flat pump curve. EQN. (2) is based on the ratio (“ω”), and a pump power (“w_{f}”).

$$Q = \frac{- {b}_{1} {ω}^{2} - \sqrt{{b}_{1}^{2} {ω}^{4} - 4 {b}_{2} ω ( {b}_{0} {ω}^{3} - {w}_{f} )}}{2 {b}_{2} ω} \qquad ( 2 )$$

In EQN. (2), b₀, b₁, and b₂ are pump power curve coefficients, also provided by manufacturers of the pumps 116, 132. In this way, the process 300 can determine the pump water flow rate (“Q”) of the pumps 116, 132 using either of the above equations as appropriate.

At block 312, the process 300 determines a time characteristic of the system 100. The time characteristic of the system 100 (also referred to as the system time characteristic) generally indicates an amount of time for water to completely flow through the system 100 (e.g., in the water flow path as described above). The process 300, after the initialization process at block 304, determines the system time characteristic (“T”) as follows.

The process 300 stores in the memory module 224 a plurality of times at which maximum and minimum supply water temperatures are recorded, and their corresponding maximum and minimum supply water temperatures. Similarly, the process 300 stores in the memory module 224 a plurality of times at which maximum and minimum return water temperatures are recorded, and their corresponding maximum and minimum supply water temperatures. The maximum and minimum return water temperatures generally occur after the corresponding times at which the maximum and minimum supply water temperatures are recorded. The process 300 then determines a difference of the times if the difference between the minimum and the maximum supply water temperatures is higher than 4° F. The process 300 then compares the time difference with a predetermined time value. When the time difference is greater than the predetermined time value, the process 300 generates a system time characteristic.

At block 316, the process 300 determines a heat rejection rate (“E”) of the system 100 with EQN. (3) as follows.

$$E = \frac{{\sum }_{i = 1}^{n} {T}_{r , i} {Q}_{i} - {\sum }_{i = m + 1}^{m + 1 + n} {T}_{s , i - m} {Q}_{i - m}}{{\sum }_{i = 1}^{n} \frac{{Q}_{i}}{2} + {\sum }_{i = m + 1}^{m + 1 + n} \frac{{Q}_{i - m}}{2}} / {nQ}_{d} ( {T}_{r , d} - {T}_{s , d} ) \qquad ( 3 )$$

In EQN. (3), the parameters include a loop return water temperature which is measured in ° F. at time i (“T_{r,i}”), a loop water flow rate at time i (“Qᵢ”), a loop supply water temperature at time (i−m) (“T_{s.i-m}”) a loop water flow rate at time (i−m) (“Qᵢ₋ₘ”), a design loop return water temperature (“T_{r,d}”), a design loop supply water temperature (“T_{s,d}”), a design loop water flow rate (“Q_{d}”), an average time period as a number of sampling intervals (“n”), and a number of sampling intervals in the system time characteristic, (“m=T/Δτ”) In general, the heat rejection ratio is between 0 and 1. For example, if E is greater than zero, the return water temperature is greater than the supply water temperature.

At block 320, the process 300 determines a loop pump speed (“Q_{loop.set}”) and a tower pump speed (“Q_{tower.set}”) with EQN. (4) and EQN. (5) as follows.
Q_{loop.set}=max(ε₀,\sqrt{|E|})Q_{loop.d} (4)
Q_{tower.set}=max(ε₀,\sqrt{|E|})Q_{tower.d} (5)
In EQN. (4) and EQN. (5), Q_{loop.d} and Q_{tower.d} are design loop flow rate and tower flow rate, respectively. In some embodiments, the constant (“ε₀”) is about 0.3.

The process 300 then proceeds to evaluate a plurality of system conditions, such as a loop pump condition, a tower pump condition, and a heat rejection rate condition. At block 324, the process 300 compares the heat rejection rate determined at block 316 with a predetermined threshold (“ε₁”), such as 0.15. If the process 300 determines at block 324 that the heat rejection rate is less than the predetermined threshold (“ε₁”), the process 300 proceeds to compare the heat rejection rate with a second predetermined threshold (“ε₂”), such as −0.05, at block 328. If the process 300 determines at block 328 that the heat rejection rate is less than the second predetermined threshold (“ε₂”), the process 300 proceeds to compare the heat rejection rate with a third predetermined threshold (“ε₃”), such as −0.1, at block 332. If the heat rejection rate is less than the third predetermined threshold (“ε₃”), the process 300 proceeds to block 336. Otherwise, if the heat rejection rate is greater than the third predetermined threshold (“ε₃”), the process 300 proceeds to block 340.

In block 336, the process 300 compares the loop supply water temperature (“Tₛ”) with the loop supply water temperature set point (“T_{s.set}”) such as 80° F. If the process 300 determines that the loop supply water temperature is less than the loop supply water temperature set point, the process 300 opens the valve 108 by an amount (“Δv”) at block 344, and repeats block 336. Otherwise, if the process 300 determines that the loop supply water temperature is greater than the loop supply water temperature set point, the process 300 closes the valve 108 by Δv at block 348 and repeats block 336. In some embodiments, the process 300 uses a proportional-integral controller (not shown) to adjust the valve 108. At block 340, the process 300 sets the loop supply water temperature set point as its maximum allowable value, (“T_{s.max}”) and repeats block 336.

At block 328, when the heat rejection rate is greater than the second predetermined threshold (“ε₂”), the process 300 proceeds to compare the loop supply water temperature (“Tₛ”) with a predetermined loop temperature (“τ₂”), such as 55° F, at block 352. If the process 300 determines that the loop supply water temperature (“Tₛ”) is less than the predetermined loop temperature (“τ₂”), the process 300 opens the valve 108 by the amount (“Δv”) at block 356, and repeats block 352. Otherwise, if the process 300 determines that the loop supply water temperature (“Tₛ”) is greater than the predetermined loop temperature (“τ₂”), the process 300 proceeds to compare the loop supply water temperature (“Tₛ”) with the loop supply water temperature set point (“T_{s.set}”) such as 80° F., at block 360. If the process 300 determines that the loop supply water temperature (“Tₛ”) is greater than the loop supply water temperature set point (“T_{s.set}”), the process 300 proceeds to turn on the cooling tower at block 364, and repeats block 360. Otherwise, in block 360, if the process 300 determines that the loop supply water temperature (“Tₛ”) is less than the loop supply water temperature set point (“T_{s.set}”), the process 300 keeps the cooling tower 136 deactivated at block 366.

At block 324, if the process 300 determines that the heat rejection rate is greater than the predetermined threshold (“ε₁”), the process 300 proceeds to carry out operations defined in block 368. At block 368, the process 300 sets the loop supply water temperature (“T_{s.set}”) according EQN. (6) as follows.
T_{s.set}=T_{wet}+ε₄E (6)
In EQN. (6), T_{wet} is an outside air wet bulb temperature, which can be determined based on the outside air temperature and the relative humidity ratio. The process 300 then compares the loop supply water temperature (“Tₛ”) with the loop supply water temperature set point (“T_{s.set}”), such as 80° F., at block 372. If the process 300 determines that the loop supply water temperature (“Tₛ”) is greater than the loop supply water temperature set point (“T_{s.set}”), the process 300 proceeds to speed up the cooling fan 148 by an amount (“Δ_{cool}”) at block 376, and repeats block 372. Otherwise, if the process 300 determines that the loop supply water temperature (“Tₛ”) is less than the loop supply water temperature set point (“T_{s.set}”), the process 300 slows down the cooling fan 148 by the amount (“Δ_{cool}”) at block 376, and repeats block 368.

Referring back to block 320, the process 300 also checks to determine the loop pump conditions. At block 382, the process 300 compares an actual loop pump flow rate with the loop pump flow rate set point determined at block 320. If the process 300 determines that the actual loop flow rate (“Qₗₒₒₚ”) is greater than the set point (“Qₗₒₒₚ”), the process 300 slows down the pump to maintain the flow rate set point by an amount (“Δₗₒₒₚ”) at block 384, and repeats block 382. Otherwise, if the process 300 determines that the actual loop flow rate (“Qₗₒₒₚ”) is less than the set point (“Qₗₒₒₚ”), the process 300 speeds up the pump to maintain the flow rate set point by the amount (“Δₗₒₒₚ”) at block 386, and repeats block 382. In some embodiments, the process 300 uses a proportional-integral controller (not shown) to adjust the loop pumps 116.

Similarly, referring back to block 320, the process 300 also checks to determine the tower pump conditions. At block 388, the process 300 compares an actual tower pump flow rate with the tower pump flow rate set point determined at block 320. If the process 300 determines that the actual tower pump flow rate (“Q_{tower}”) is greater than the set point (“Q_{tower}”) the process 300 slows down the tower pump to maintain the flow rate set point by an amount (“Δ_{tower}”) at block 390, and repeats block 388. Otherwise, if the process 300 determines that the actual tower flow rate (“Q_{tower}”) is less than the set point (“Q_{tower}”), the process 300 speeds up the tower pump to maintain the tower pump flow rate set point by the amount (“Δ_{tower}”) at block 392, and repeats block 388. In some embodiments, the process 300 uses a proportional-integral controller (not shown) to adjust the tower pumps 132.

Various features and advantages of the invention are set forth in the following claims.

What is claimed is:

1. A method of controlling a water heat pump system including a fan, a water pump, and a boiler, the method comprising:
determining a system time characteristic;
determining a heat rejection rate based on the system time characteristic;
determining a loop flow rate based on the heat rejection rate;
sensing a loop flow rate of the water heat pump system;
comparing the sensed loop flow rate with the determined loop flow rate; and
modulating a speed of the water pump based on the comparing.

2. The method of claim 1, further comprising modulating a speed of the fan to maintain a loop return water temperature set point.

3. The method of claim 1, further comprising determining a loop supply water temperature set point based on the heat rejection rate.

4. The method of claim 1, wherein the system time characteristic comprises a constant indicative of a time period over which water flows substantially through the water heat pump system.

5. The method of claim 4, wherein determining the system time characteristic comprises updating the constant based on measured times associated with maximum and minimum supply water temperatures and with maximum and minimum return water temperatures.

6. The method of claim 1, wherein the heat rejection rate is further determined based on a loop supply water temperature and a loop return water temperature measured at a plurality of times.

7. The method of claim 1, wherein the water pump is a loop heat pump.

8. The method of claim 1, wherein the water pump is a cooling tower pump.

9. The method of claim 1, wherein the fan is a cooling tower fan.

10. A controller for controlling a water heat pump system including a variable speed cooling tower fan, a water pump, a boiler operable to supply water at a plurality of temperatures, and a sensing device operable to sense a loop flow rate of the water heat pump system, the controller comprising:
a timing module configured to determine a system time characteristic;
a heat rejection module configured to determine a heat rejection rate based on the system time characteristic;
a loop flow module configured to determine a loop flow rate based on the heat rejection rate;
a comparator configured to compare the sensed loop flow rate with the determined loop flow rate; and
a modulator configured to modulate a speed of the water pump based on the comparing by the comparator.

11. The controller of claim 10, wherein the modulator is further configured to modulate a speed of the fan to maintain a loop return water temperature set point.

12. The controller of claim 10, further comprising a set point module configured to determine a loop supply water temperature set point based on the heat rejection rate.

13. The controller of claim 10, wherein the system time characteristic comprises a constant indicative of a time period over which water flows substantially through the water heat pump system.

14. The controller of claim 13, wherein the timing module is further configured to update the constant based on measured times associated with maximum and minimum supply water temperatures and with maximum and minimum return water temperatures.

15. The controller of claim 10, wherein the heat rejection rate is determined by the heat rejection module based on a loop supply water temperature and a loop return water temperature measured at a plurality of times.

16. The controller of claim 10, wherein the water pump is a loop heat pump.

17. The controller of claim 10, wherein the water pump is a cooling tower pump.
